(19) United States
(12) Patent Application Publication
(10) Pub. No.: US 2021/0300318 A1
(43) Pub. Date: Sep. 30, 2021

(54) VEHICLE CONTROL DEVICE

(71) Applicant: TOYOTA JIDOSHA KABUSHIKI KAISHA, Aichi-ken (JP)

(72) Inventors: Yasuhiro HIASA, Miyoshi-shi (JP); Yasutaka TSUCHIDA, Toyota-shi (JP)

(21) Appl. No.: 17/165,943

(22) Filed: Feb. 3, 2021

(30) Foreign Application Priority Data
Mar. 31, 2020 (JP) 2020-063963

(51) Int. Cl. B60W 10/30; B60W 10/06; B60W 10/10; F01N 3/021; F01N 9/00; B60W 20/30

(52) U.S. Cl. CPC B60W 10/30; B60W 10/06; B60W 10/10; F01N 3/021; B60H 1/00878; B60W 20/30; F01N 2900/08; F01N 2590/11; F01N 9/00

(57) ABSTRACT

The present disclosure relates to a control device for a vehicle. The vehicle includes an engine as a drive source, a motor generator as a drive source, a battery for storing electric power generated by the motor generator using an output of the engine, and an exhaust treatment device provided in an exhaust passage of the engine. The control device is configured to execute a temperature rise control that increases the output of the engine and raises a temperature of exhaust gas flowing into the exhaust treatment device.

### CROSS-REFERENCE TO RELATED APPLICATION

This application claims priority to Japanese Patent Application No. 2020-063963 filed on Mar. 31, 2020, incorporated herein by reference in its entirety.

### BACKGROUND

### 1. Technical Field

The present disclosure relates to a vehicle control device.

### 2. Description of Related Art

A vehicle described in Japanese Unexamined Patent Application Publication No. 2017-149233 (JP 2017-149233 A) includes an engine and a motor generator as a drive source. The vehicle is equipped with a battery that stores electric power generated by the motor generator using the output of the engine. The vehicle is equipped with a filter located in an exhaust passage of the engine. The filter collects particulate matter flowing through the exhaust passage.

The vehicle control device increases the output of the engine when performing temperature rise control that raises the temperature of the exhaust gas flowing into the filter to burn the particulate matter in the filter. As a result, the temperature of the exhaust gas flowing into the filter rises, and the temperature of the filter gradually rises. Of the output of the engine, the output that is not used for traveling of the vehicle is converted into electric power by power generation of the motor generator and stored in the battery.

### SUMMARY

The maximum output of the engine changes depending on the operating state of the engine such as the rotation speed of the engine. Depending on the operating state of the engine, the actual output of the engine may be smaller than the output in which the increase in the output of the engine due to the execution of the temperature rise control is taken into account. As a result, when the temperature rise control is executed, the output that can be actually used for traveling may be smaller than the output required by a driver. It should be noted that such a situation also occurs when the temperature rise control is executed for an exhaust treatment device other than the filter such as a catalyst device.

A first aspect of the present disclosure relates to a control device for a vehicle. The vehicle includes an engine as a drive source, a motor generator as a drive source, a battery for storing electric power generated by the motor generator using an output of the engine, and an exhaust treatment device provided in an exhaust passage of the engine. The control device is configured to execute a temperature rise control that increases the output of the engine and raises a temperature of exhaust gas flowing into the exhaust treatment device. The control device includes an electronic control unit configured to: calculate a first target value that is a target value of the output of the engine used for traveling of the vehicle, based on an accelerator operation of a driver; calculate a second target value that is a target value of the output of the engine and that is larger than the first target value, when executing the temperature rise control; calculate an upper limit value of the output of the engine based on an operating state of the engine; and execute a restriction process for restricting the electric power generated by the motor generator such that, of the output of the engine, an output for power generation used for power generation of the motor generator does not exceed an output corresponding to a subtraction value obtained by subtracting the first target value from the upper limit value, when the temperature rise control is executed and the second target value is larger than the upper limit value.

According to the above configuration, compared to the case where the power generation of the motor generator is executed using the output exceeding the output corresponding to the subtraction value obtained by subtracting the first target value from the upper limit value, the output of the engine that can be actually used for traveling of the vehicle increases. As a result, it is possible to suppress the output of the engine actually used for traveling of the vehicle from becoming smaller than the output of the engine required by the driver.

In the above aspect, the electronic control unit may be configured to set an amount of change in the electric power generated by the motor generator per unit time to a value equal to or less than a specified value when the restriction process is executed.

When the temperature rise control is started, the output of the engine increases and the electric power generated by the motor generator also increases. Here, the electric power generated by the motor generator can be increased at a speed higher than that of the output of the engine. Therefore, when the temperature rise control is executed, the output that can be used for traveling of the vehicle may become temporarily smaller than the output required by the driver as the electric power generated by the motor generator increases.

According to the above configuration, the increase rate of the electric power generated by the motor generator is smaller as compared with the case where the amount of change in the electric power generated by the motor generator per unit time exceeds the specified value. Thus, it is possible to suppress the output that can be used for traveling of the vehicle from becoming smaller than the output required by the driver.

In the above aspect, the electronic control unit may be configured to execute an increase process for increasing the upper limit value when the temperature rise control is executed and the second target value is larger than the upper limit value.

According to the above configuration, the actual output of the engine can be increased as compared with the case where the upper limit value is not increased, so that the output actually used for traveling of the vehicle can be suppressed from becoming smaller due to the small actual output of the engine.

In the above aspect, the vehicle may have a speed change mechanism on a power transmission path between the engine and drive wheels, the speed change mechanism being configured to change a gear ratio that is a ratio of a rotation speed of the drive wheels with respect to a rotation speed of the engine.

The increase process may be a gear ratio change process for increasing the gear ratio of the speed change mechanism.

When the gear ratio changed by the speed change mechanism is fixed to a specific gear ratio, the rotation speed of the engine is uniquely determined in accordance with the specific gear ratio and the vehicle speed. When the rotation speed of the engine is uniquely determined, the upper limit value of the output of the engine is likely to be restricted.

According to the above configuration, the engine rotation speed increases even when the vehicle speed is constant. As a result, the upper limit value of the output of the engine can be raised by increasing the engine rotation speed.

In the above aspect, the speed change mechanism may be a speed change mechanism configured to change the gear ratio stepwise. The gear ratio change process may be a process of shifting a gear range of the speed change mechanism to a low speed side. According to the above configuration, the rotation speed of the engine can be increased by increasing the gear ratio by shifting the gear range.

In the above aspect, the increase process may be a process of changing an air-fuel ratio in cylinders of the engine to an air-fuel ratio on a rich side. In a predetermined range in which the air-fuel ratio in the cylinders of the engine is close to the stoichiometric air-fuel ratio, the richer the air-fuel ratio, the larger the torque of the engine. According to the above configuration, the torque of the engine can be increased even when the rotation speed of the engine is constant. As a result, the upper limit value of the output of the engine can be raised by increasing the torque of the engine.

In the above aspect, the electronic control unit may be configured to calculate a value obtained by adding at least one of an auxiliary machine driving force for driving an auxiliary machine and an air conditioning driving force for driving an air conditioner to an output used for traveling of the vehicle as the first target value.

If the first target value does not include the auxiliary machine driving force and the air conditioning driving force, the output actually used for traveling may become smaller as the auxiliary machine driving force and the air conditioning driving force increase. According to the above configuration, the first target value is calculated by taking into account the auxiliary machine driving force and the air conditioning driving force, so that it is possible to suppress the output actually used for traveling from becoming smaller as the auxiliary machine driving force and the air conditioning driving force change.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a vehicle;

FIG. 2 is an explanatory diagram showing a relationship between a vehicle speed and an engine rotation speed;

FIG. 3 is an explanatory diagram showing a relationship between the engine rotation speed and an engine output;

FIG. 4 is a flowchart showing restriction control; and

FIG. 5 is an explanatory diagram showing a restriction process in the restriction control.

### DETAILED DESCRIPTION OF EMBODIMENTS

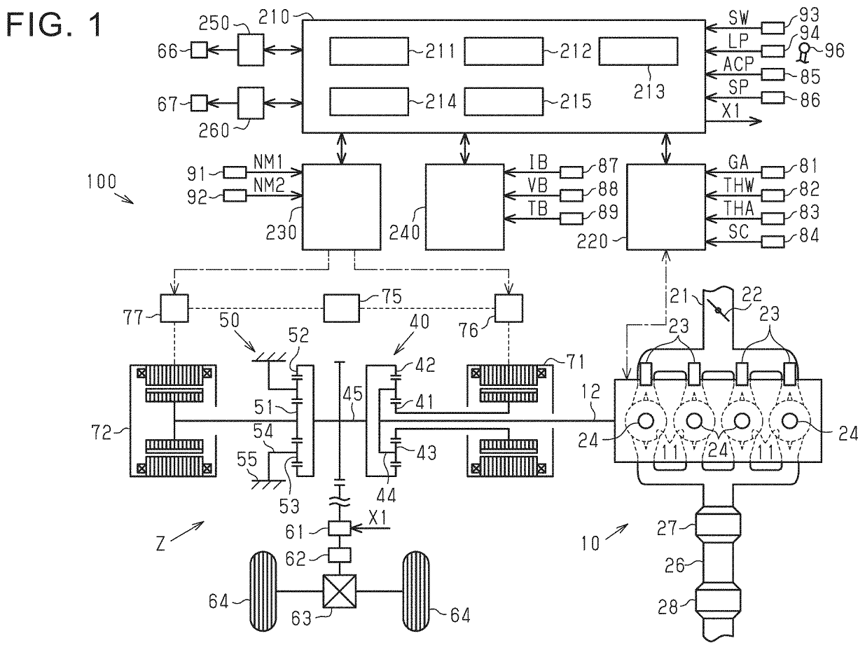

Hereinafter, an embodiment of the vehicle control device will be described with reference to FIGS. 1 to 5. First, the schematic configuration of a vehicle 100 will be described. As shown in FIG. 1, the vehicle 100 includes a spark-ignition engine 10. The vehicle 100 includes a first motor generator 71 and a second motor generator 72, which are two motor generators each having both functions of an electric motor and a generator. Therefore, the vehicle 100 is a so-called hybrid vehicle.

The engine 10 includes a plurality of cylinders 11, a crankshaft 12, an intake passage 21, a throttle valve 22, a plurality of fuel injection valves 23, a plurality of ignition devices 24, an exhaust passage 26, a three-way catalyst 27, and a filter 28.

In the cylinder 11, the air-fuel mixture of the fuel and the intake air burns. The engine 10 includes four cylinders 11. The intake passage 21 is connected to the cylinders 11. The downstream portion of the intake passage 21 is branched into four and is connected to each cylinder 11. The intake passage 21 introduces intake air into each cylinder 11 from the outside of the engine 10.

The throttle valve 22 is disposed in a portion of the intake passage 21 on the upstream side of the branched portion. The throttle valve 22 adjusts the amount of intake air flowing through the intake passage 21.

The engine 10 includes four fuel injection valves 23 that each correspond to the four cylinders 11. The fuel injection valves 23 are arranged in a branched portion of the intake passage 21. The fuel injection valves 23 inject fuel supplied from a fuel tank (not shown) into the intake passage 21. Each of the ignition devices 24 is arranged for each cylinder 11. That is, the engine 10 includes four ignition devices 24. The ignition devices 24 ignite the air-fuel mixture of the fuel and the intake air by spark discharge.

The exhaust passage 26 is connected to the cylinders 11. The upstream portion of the exhaust passage 26 is branched into four and is connected to each cylinder 11. The exhaust passage 26 exhausts exhaust gas from each cylinder 11 to the outside of the engine 10.

The three-way catalyst 27 is disposed in a portion of the exhaust passage 26 on the downstream side of the branched portion. The three-way catalyst 27 reduces the exhaust gas flowing through the exhaust passage 26. The filter 28 is disposed in a portion of the exhaust passage 26 on the downstream side of the three-way catalyst 27. The filter 28 collects particulate matter contained in the exhaust gas flowing through the exhaust passage 26.

The crankshaft 12 is connected to pistons (not shown) arranged in each cylinder 11. The crankshaft 12 rotates when the air-fuel mixture of the fuel and the intake air burns in the cylinders 11 and the pistons reciprocate.

The vehicle 100 includes a battery 75, a first inverter 76, and a second inverter 77. When the first motor generator 71 or the second motor generator 72 functions as a generator, the battery 75 stores the electric power generated by the first motor generator 71 or the second motor generator 72. When the first motor generator 71 or the second motor generator 72 functions as an electric motor, the battery 75 supplies electric power to the first motor generator 71 or the second motor generator 72.

The first inverter 76 adjusts the amount of electric power exchanged between the first motor generator 71 and the battery 75. The second inverter 77 adjusts the amount of electric power exchanged between the second motor generator 72 and the battery 75.

The vehicle 100 includes a first planetary gear mechanism 40, a ring gear shaft 45, a second planetary gear mechanism 50, an automatic transmission 61, a reduction mechanism 62, a differential mechanism 63, and a plurality of drive wheels 64. The first planetary gear mechanism 40 includes a sun gear 41, a ring gear 42, a plurality of pinion gears 43, and a carrier 44. The sun gear 41 is an external gear. The sun gear 41 is connected to the first motor generator 71. The ring gear 42 is an internal gear and is arranged coaxially with the sun gear 41. The pinion gears 43 are arranged between the sun gear 41 and the ring gear 42. Each pinion gear 43 meshes with both the sun gear 41 and the ring gear 42. The carrier 44 supports the pinion gears 43 such that the pinion gears 43 are rotatable and revolvable. The carrier 44 is connected to the crankshaft 12.

The ring gear shaft 45 is connected to the ring gear 42. The automatic transmission 61 is connected to the ring gear shaft 45. The automatic transmission 61 is connected to the drive wheels 64 via the reduction mechanism 62 and the differential mechanism 63. The automatic transmission 61 is a stepped automatic transmission that has a plurality of planetary gear mechanisms and that changes the gear ratio stepwise. The automatic transmission 61 switches the gear ratio by shifting the gear range.

The second planetary gear mechanism 50 includes a sun gear 51, a ring gear 52, a plurality of pinion gears 53, a carrier 54, and a case 55. The sun gear 51 is an external gear. The sun gear 51 is connected to the second motor generator 72. The ring gear 52 is an internal gear and is arranged coaxially with the sun gear 51. The ring gear 52 is connected to the ring gear shaft 45. The pinion gears 53 are arranged between the sun gear 51 and the ring gear 52. Each pinion gear 53 meshes with both the sun gear 51 and the ring gear 52. The carrier 54 supports the pinion gears 53 such that the pinion gears 53 are rotatable. The carrier 54 is fixed to the case 55. Thus, the pinion gears 53 are not revolvable.

The vehicle 100 includes an auxiliary machine 66 and an air conditioner 67. The auxiliary machine 66 is driven by the electric power generated by using a part of the output of the engine 10. Examples of the auxiliary machine 66 include a water pump that supplies a coolant to each part of the engine 10, an oil pump that supplies oil to each part of the engine 10, and the like. The air conditioner 67 is driven by the electric power generated by using a part of the output of the engine 10. The air conditioner 67 adjusts the temperature of the vehicle cabin of the vehicle 100 by adjusting the temperature and the volume of the air discharged from the air conditioner 67.

The vehicle 100 includes a shift lever 96. The shift lever 96 is switched to a non-traveling position or a traveling position by the driver. Here, the non-traveling position is a position where the vehicle 100 does not travel, namely, for example, a parking position or a neutral position. When the shift lever 96 is in the non-traveling position, the automatic transmission 61 establishes a gear range for non-traveling. The traveling position is a position where the vehicle 100 travels, namely, for example, a forward traveling position or a reverse traveling position.

When the shift lever 96 is in the traveling position, the automatic transmission 61, the first motor generator 71, the second motor generator 72, the first planetary gear mechanism 40, and the second planetary gear mechanism 50 are used to establish the gear range for traveling.

Thus, in the present embodiment, the automatic transmission 61, the first motor generator 71, the second motor generator 72, the first planetary gear mechanism 40, and the second planetary gear mechanism 50 function as a speed change mechanism Z that changes the gear ratio, which is the ratio of the rotation speed of the drive wheels 64 with respect to the rotation speed of the crankshaft 12 of the engine 10. The speed change mechanism Z is disposed on the power transmission path between the crankshaft 12 of the engine 10 and the drive wheels 64. Here, the gear ratio of the speed change mechanism Z is a ratio indicating the number of rotations of the crankshaft 12 of the engine 10 when the drive wheels 64 rotate once.

In the present embodiment, when the shift lever 96 is in the forward traveling position, 10 gear ranges from “first gear” to “tenth gear” can be established in the speed change mechanism Z. When the gear range of the speed change mechanism Z is shifted, the gear ratio of the speed change mechanism Z is set to a gear ratio that is predetermined according to each gear range. The gear ratio of the speed change mechanism Z is smaller at the higher gear range of the speed change mechanism Z. The first motor generator 71, the second motor generator 72, the first planetary gear mechanism 40, and the second planetary gear mechanism 50 can continuously change the gear ratio, and can establish a pseudo gear range by selecting a specific gear ratio from a plurality of predetermined gear ratios when establishing the gear range. Therefore, in the speed change mechanism Z, a total of 10 gear ranges are established by combining a plurality of pseudo gear ranges in the first motor generator 71, the second motor generator 72, the first planetary gear mechanism 40, and the second planetary gear mechanism 50, and a plurality of gear ranges defined by the mechanical configuration of the automatic transmission 61.

The vehicle 100 includes an air flow meter 81, a coolant temperature sensor 82, an intake air temperature sensor 83, a crank angle sensor 84, an accelerator position sensor 85, a vehicle speed sensor 86, a current sensor 87, a voltage sensor 88, and a temperature sensor 89.

The air flow meter 81 detects the intake air amount GA, which is the amount of intake air flowing through the intake passage 21 per unit time. The coolant temperature sensor 82 detects the coolant temperature THW, which is the temperature of the coolant flowing through each part of the engine 10. The intake air temperature sensor 83 detects the intake air temperature THA, which is the temperature of the intake air flowing through the intake passage 21. The crank angle sensor 84 detects the crank angle SC, which is the rotation angle of the crankshaft 12. The accelerator position sensor 85 detects the accelerator operation amount ACP, which is the operation amount of the accelerator pedal operated by the driver. The vehicle speed sensor 86 detects the vehicle speed SP, which is the speed of the vehicle 100. The current sensor 87 detects the current IB, which is the current input to/output from the battery 75. The voltage sensor 88 detects the voltage VB, which is the voltage between the terminals of the battery 75. The temperature sensor 89 detects the battery temperature TB, which is the temperature of the battery 75.

The vehicle 100 includes a first rotation speed sensor 91, a second rotation speed sensor 92, a start switch 93, and a lever position sensor 94. The first rotation speed sensor 91 detects the first rotation speed NM1, which is the number of rotations of the rotor of the first motor generator 71 per unit time. The second rotation speed sensor 92 detects the second rotation speed NM2, which is the number of rotations of the rotor of the second motor generator 72 per unit time. The start switch 93 is a switch for starting or ending the operation of the system of the vehicle 100. The start switch 93 detects a switch operation SW indicating the operation of the start switch 93 operated by the driver. The lever position sensor 94 detects the lever position LP, which is the operating position of the shift lever 96 operated by the driver.

The vehicle 100 includes a hybrid electronic control unit (ECU) 210, an engine ECU 220, a motor ECU 230, a battery ECU 240, an auxiliary machine ECU 250, and an air conditioning ECU 260. The hybrid ECU 210 can communicate with each of the engine ECU 220, the motor ECU 230, the battery ECU 240, the auxiliary machine ECU 250, and the air conditioning ECU 260.

A signal indicating the intake air amount GA is input to the engine ECU 220 from the air flow meter 81. A signal indicating the coolant temperature THW is input to the engine ECU 220 from the coolant temperature sensor 82. A signal indicating the intake air temperature THA is input to the engine ECU 220 from the intake air temperature sensor 83. A signal indicating the crank angle SC is input to the engine ECU 220 from the crank angle sensor 84.

The engine ECU 220 calculates the engine rotation speed NE, which is the number of rotations of the crankshaft 12 per unit time, based on the crank angle SC. The engine ECU 220 calculates the engine load factor KL based on the engine rotation speed NE and the intake air amount GA. Here, the engine load factor KL represents the ratio of the current cylinder inflow air amount with respect to the cylinder inflow air amount when the engine 10 is steadily operated with the throttle valve 22 fully open at the current engine rotation speed NE. The cylinder inflow air amount is the amount of intake air flowing into each cylinder 11 in the intake stroke.

The engine ECU 220 calculates the catalyst temperature TSC, which is the temperature of the three-way catalyst 27, based on the operating state of the engine 10 such as the filling efficiency of the intake air and the engine rotation speed NE. The engine ECU 220 calculates the filter temperature TF, which is the temperature of the filter 28, based on the operating state of the engine 10 such as the filling efficiency of the intake air and the engine rotation speed NE. The engine ECU 220 calculates the particulate matter (PM) accumulation amount PS, which is the accumulation amount of particulate matter in the filter 28, based on the engine rotation speed NE, the engine load factor KL, and the filter temperature TF.

When the PM accumulation amount PS reaches a predetermined regeneration specified value and a regeneration request for the filter 28 is generated, the engine ECU 220 executes temperature rise control that increases the output of the engine 10 and raises the temperature of the exhaust gas flowing into the filter 28. When the filter temperature TF reaches a predetermined temperature by the temperature rise control, the particulate matter burns in the filter 28, so that the particulate matter in the filter 28 is reduced and the filter 28 is regenerated. Of the output of the engine 10 that is increased by the execution of the temperature rise control of the filter 28, the output that is not used for traveling of the vehicle 100 is converted into electric power by the first motor generator 71 and stored in the battery 75. In the present embodiment, the filter 28 is an example of an exhaust treatment device.

The engine ECU 220 can communicate with the engine 10. The engine ECU 220 controls the engine 10. Specifically, the engine ECU 220 executes the control of the amount of intake air introduced into the cylinders 11 through the throttle valve 22, the amount of fuel introduced into the cylinders 11 through the fuel injection valves 23, and the like.

A signal indicating the first rotation speed NM1 is input to the motor ECU 230 from the first rotation speed sensor 91. A signal indicating the second rotation speed NM2 is input to the motor ECU 230 from the second rotation speed sensor 92. The motor ECU 230 can communicate with the first inverter 76 and the second inverter 77. The motor ECU 230 controls the first motor generator 71 through the first inverter 76. The motor ECU 230 controls the second motor generator 72 through the second inverter 77.

A signal indicating the current IB is input to the battery ECU 240 from the current sensor 87. A signal indicating the voltage VB is input to the battery ECU 240 from the voltage sensor 88. A signal indicating the battery temperature TB is input to the battery ECU 240 from the temperature sensor 89.

The battery ECU 240 calculates the charge rate SOC of the battery 75 based on the current IB, the voltage VB, and the battery temperature TB. The charge rate SOC calculated by the battery ECU 240 is higher as the amount by which the current IB input to the battery 75 is larger than the current IB output from the battery 75. The charge rate SOC calculated by the battery ECU 240 increases as the voltage VB increases. The charge rate SOC calculated by the battery ECU 240 is lower as the battery temperature TB is lower.

The charge rate SOC is represented by the following equation.

Charge rate SOC [%]=Battery remaining capacity [Ah]/Battery full charge capacity [Ah]×100[%] Equation (1):

Charge control of the battery 75 is executed so that the charge rate SOC of the battery 75 falls within the range between the charge rate upper limit value SOCH and the charge rate lower limit value SOCL. The charge rate upper limit value SOCH is, for example, 60%. The charge rate lower limit value SOCL is, for example, 30%.

The auxiliary machine ECU 250 can communicate with the auxiliary machine 66. The auxiliary machine ECU 250 controls the auxiliary machine 66. The air conditioning ECU 260 can communicate with the air conditioner 67. The air conditioning ECU 260 controls the air conditioner 67.

A signal indicating the accelerator operation amount ACP is input to the hybrid ECU 210 from the accelerator position sensor 85. A signal indicating the vehicle speed SP is input to the hybrid ECU 210 from the vehicle speed sensor 86. A signal indicating the switch operation SW is input to the hybrid ECU 210 from the start switch 93. A signal indicating the lever position LP is input to the hybrid ECU 210 from the lever position sensor 94.

The hybrid ECU 210 includes a first target value calculation unit 211, a second target value calculation unit 212, an upper limit value calculation unit 213, a restriction processing execution unit 214, and an increase processing execution unit 215. The first target value calculation unit 211 calculates the first target value A, which is the target value of the output of the engine 10. In calculating the first target value A, first, the first target value calculation unit 211 calculates the vehicle required output, which is a required value for the vehicle 100 to travel, based on the accelerator operation amount ACP and the vehicle speed SP. The required value required for the vehicle 100 to travel is the required value of the output of the hybrid system composed of the engine 10, the first motor generator 71, and the second motor generator 72, which is required for the vehicle 100 to travel. Further, the first target value calculation unit 211 selects the gear range of the speed change mechanism Z based on the accelerator operation amount ACP and the vehicle speed SP. The first target value calculation unit 211 determines the output distribution of the engine 10, the first motor generator 71, and the second motor generator 72 based on the vehicle required output, the gear range of the speed change mechanism Z, and the charge rate SOC. The first target value calculation unit 211 uses the output distribution of the engine 10 as the first target value A. Here, the first target value A is a value obtained by adding the target value of the auxiliary machine driving force for driving the auxiliary machine 66 and the air conditioning driving force for driving the air conditioner 67 to the target value of the output used for traveling of the vehicle 100. The target value of the output used for traveling of the vehicle 100 is a target value of the driving force transmitted from the crankshaft 12 of the engine 10 to the drive wheels 64. The first target value calculation unit 211 calculates the target value of the output of the first motor generator 71 and the target value of the output of the second motor generator 72 based on the output distribution of the first motor generator 71 and the second motor generator 72. That is, the hybrid ECU 210 is an electronic control unit.

The second target value calculation unit 212 calculates the second target value B, which is the target value of the output of the engine 10, based on the first target value A. The second target value calculation unit 212 calculates the second target value B as a value larger than the first target value A when the temperature rise control is executed. That is, the second target value B is calculated as a target value of the output of the engine 10 for increasing the output of the engine 10 when the temperature rise control is executed.

The upper limit value calculation unit 213 calculates the upper limit value C of the output of the engine 10 based on the operating state of the engine 10. When the second target value B is larger than the upper limit value C, the increase processing execution unit 215 executes the increase process for increasing the upper limit value C.

When executing the temperature rise control of the filter 28, of the output of the engine 10, the restriction processing execution unit 214 executes a restriction process of restricting the electric power generated by the first motor generator 71 from the output of the engine 10. The restriction processing execution unit 214 adjusts the electric power generated by the first motor generator 71 from the output of the engine 10 by controlling the torque of the first motor generator 71 through the first inverter 76. Further, when executing the temperature rise control of the filter 28, the restriction processing execution unit 214 controls the first inverter 76 so that the amount of change in the electric power generated by the first motor generator 71 from the output of the engine 10 per unit time is equal to or less than a specified value. Here, in setting the specified value, the amount of change in which the output of the engine 10 changes per unit time is obtained by experiments or the like. The specified value is predetermined to be smaller by a predetermined value than the amount of change in which the output of the engine 10 changes per unit time. In the present embodiment, the specified value is a constant value. In the present embodiment, the hybrid ECU 210 is an example of a vehicle control device.

Next, the control of the vehicle 100 performed by the hybrid ECU 210 will be described. The hybrid ECU 210 controls the output of the engine 10 based on the first target value A when the temperature rise control of the filter 28 is not executed. On the other hand, the hybrid ECU 210 controls the output of the engine 10 based on the second target value B when the temperature rise control of the filter 28 is executed. The hybrid ECU 210 controls the power running/regeneration of the first motor generator 71 and the second motor generator 72 based on the target value of the output of the first motor generator 71 and the target value of the output of the second motor generator 72. The hybrid ECU 210 controls the engine 10 through the engine ECU 220. Further, the hybrid ECU 210 controls the first motor generator 71 and the second motor generator 72 through the motor ECU 230. Further, the hybrid ECU 210 controls the automatic transmission 61 by outputting to the automatic transmission 61 a transmission signal X1 that is a signal for shifting the gear range of the automatic transmission 61.

When the vehicle 100 travels, the hybrid ECU 210 selects either an electric vehicle (EV) mode or a hybrid vehicle (HV) mode as the traveling mode of the vehicle 100. Here, the EV mode is a mode in which the vehicle 100 travels with the driving force of the first motor generator 71 or the driving force of the second motor generator 72 without driving the engine 10. The HV mode is a mode in which the vehicle 100 travels with the driving force of the engine 10 in addition to the driving force of the first motor generator 71 and the second motor generator 72.

The hybrid ECU 210 selects the EV mode when the vehicle 100 starts and when the vehicle 100 is traveling with a light load in the case where the charge rate SOC is higher than the charge rate lower limit value SOCL, that is, when there is sufficient room in the remaining capacity of the battery 75.

On the other hand, the hybrid ECU 210 selects the HV mode when the charge rate SOC is equal to or lower than the charge rate lower limit value SOCL. In this case, the hybrid ECU 210 drives the engine 10 and drives the first motor generator 71 with the driving force of the engine 10 to generate electric power. Then, the hybrid ECU 210 executes charge control for charging the battery 75 with the electric power generated by the first motor generator 71. Further, the hybrid ECU 210 causes the vehicle 100 to travel with a part of the driving force of the engine 10 and the driving force of the second motor generator 72.

The hybrid ECU 210 selects the HV mode in the following cases even when the charge rate SOC is higher than the charge rate lower limit value SOCL. For example, the HV mode is selected when the vehicle speed SP exceeds the upper limit speed of the EV mode, when high load traveling of the vehicle 100 is required, when sudden acceleration of the vehicle 100 is required, when the engine 10 needs to be started, etc. When starting the engine 10, the crankshaft 12 is rotated with the driving force of the first motor generator 71 to start the engine 10.

The hybrid ECU 210 stops the engine 10 when deceleration of the vehicle 100 is required. Then, the hybrid ECU 210 causes the second motor generator 72 to function as a generator, and charges the battery 75 with the electric power generated by the second motor generator 72.

When the vehicle 100 is stopped, the hybrid ECU 210 switches the control while the vehicle 100 is stopped in accordance with the magnitude of the charge rate SOC. Specifically, the hybrid ECU 210 does not drive the engine 10, the first motor generator 71, and the second motor generator 72 when the charge rate SOC is higher than the charge rate lower limit value SOCL. On the other hand, when the charge rate SOC is equal to or lower than the charge rate lower limit value SOCL, the hybrid ECU 210 drives the engine 10 and drives the first motor generator 71 with the driving force of the engine 10 to generate electric power. Then, the hybrid ECU 210 executes the charge control for charging the battery 75 with the electric power generated by the first motor generator 71.

The hybrid ECU 210 selects the HV mode when warm-up of the engine 10 is required. The hybrid ECU 210 continues to select the HV mode until the warm-up of the engine 10 is completed, and continues to drive the engine 10 to complete the warm-up of the engine 10.

The hybrid ECU 210, the engine ECU 220, the motor ECU 230, the battery ECU 240, the auxiliary machine ECU 250, and the air conditioning ECU 260 can be configured as a circuit (circuitry) including one or more processors that execute various processes according to a computer program (software). The hybrid ECU 210, the engine ECU 220, the motor ECU 230, the battery ECU 240, the auxiliary machine ECU 250, and the air conditioning ECU 260 may be configured as one or more dedicated hardware circuits such as application specific integrated circuits (ASICs) that execute at least a part of the various processes, or a circuit including a combination thereof. The processor includes a central processing unit (CPU) and a memory such as a random access memory (RAM) and a read only memory (ROM). The memory stores a program code or a command configured to cause the CPU to execute the process. A memory, that is, a computer-readable medium includes any medium accessible by a general purpose computer or a dedicated computer.

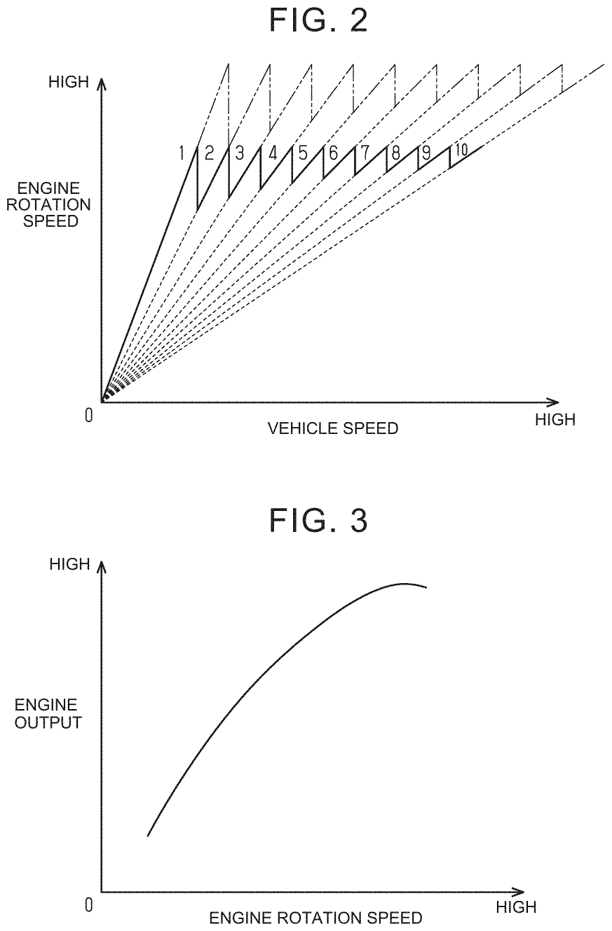

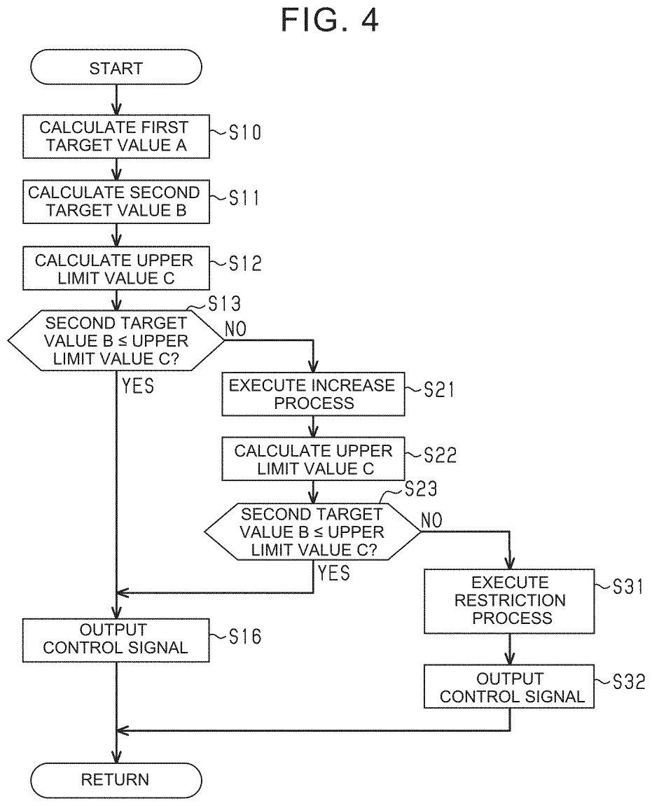

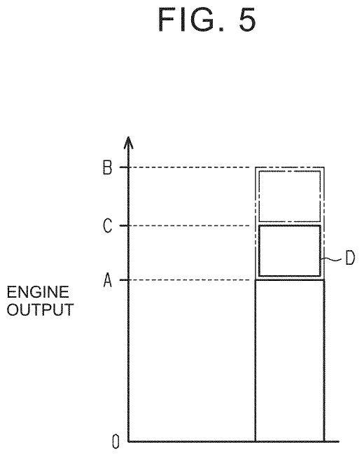

As shown by the solid line in FIG. 2, assuming that the accelerator operation amount ACP is a constant value, the gear range of the speed change mechanism Z is shifted in accordance with the vehicle speed SP. When the gear range of the speed change mechanism Z is set in accordance with the vehicle speed SP in this way, the engine rotation speed NE is uniquely determined in accordance with the vehicle speed SP. Here, as shown in FIG. 3, the output of the engine 10 generally increases as the engine rotation speed NE increases. However, as described above, once the engine rotation speed NE is determined, the output of the engine 10 cannot be changed by changing the engine rotation speed NE. Therefore, when the gear range of the speed change mechanism Z is set in accordance with the vehicle speed SP, the upper limit value C of the output of the engine 10 is likely to be restricted. In this case, as shown in FIG. 5, the second target value B calculated when the temperature rise control of the filter 28 is executed may be larger than the upper limit value C. Here, for example, of the output of the engine 10, when the output corresponding to the subtraction value obtained by subtracting the first target value A from the second target value B is converted into electric power by the power generation of the first motor generator 71 and charged in the battery 75, the output of the engine 10 that can be used for traveling of the vehicle 100 of the output of the engine 10 becomes smaller. As a result, the output that can be actually used for traveling of the vehicle 100 as a whole of the vehicle 100 may be smaller than the vehicle required output required by the driver. Therefore, in the present embodiment, the hybrid ECU 210 executes the restriction control shown in FIG. 4.

Next, the restriction control executed by the hybrid ECU 210 will be described with reference to FIG. 4. The hybrid ECU 210 repeatedly executes the restriction control from the time when the execution of the temperature rise control of the filter 28 is started to the time when the execution is finished.

As shown in FIG. 4, in starting the restriction control, the hybrid ECU 210 proceeds to the process of step S10. In step S10, the first target value calculation unit 211 calculates the first target value A based on the accelerator operation amount ACP and the vehicle speed SP. After that, the first target value calculation unit 211 proceeds to the process of step S11.

In step S11, the second target value calculation unit 212 calculates the second target value B, which is larger than the first target value A. Specifically, the second target value calculation unit 212 calculates the second target value B by adding a predetermined value to the first target value A. The predetermined value is a value set as an initial value of the output of the engine 10 that is used for power generation of the first motor generator 71 of the output of the engine 10 when the temperature rise control of the filter 28 is executed. After that, the second target value calculation unit 212 proceeds to the process of step S12.

In step S12, the upper limit value calculation unit 213 calculates the upper limit value C of the output of the engine 10 based on the operating state of the engine 10 at the time of processing in step S12. Specifically, the upper limit value calculation unit 213 calculates the upper limit value C based on the engine rotation speed NE, the air-fuel ratio in the cylinders 11, and the like. After that, the upper limit value calculation unit 213 proceeds to the process of step S13.

In step S13, the restriction processing execution unit 214 determines whether the second target value B at the time of processing in step S11 is equal to or less than the upper limit value C at the time of processing in step S12. In step S13, when the restriction processing execution unit 214 determines that the second target value B at the time of processing in step S11 is equal to or less than the upper limit value C at the time of processing in step S12 (S13: YES), the process proceeds to step S16.

On the other hand, in step S13, when the restriction processing execution unit 214 determines that the second target value B at the time of processing in step S11 is larger than the upper limit value C at the time of processing in step S12 (S13: NO), the process proceeds to step S21.

In step S21, the increase processing execution unit 215 executes the increase process for increasing the upper limit value C. Specifically, the increase processing execution unit 215 shifts the gear range of the speed change mechanism Z selected when the vehicle speed SP is the same to the low speed side. For example, as shown by long dashed double-short dashed lines in FIG. 2, when the vehicle speed SP is the same, the gear range of the speed change mechanism Z is shifted to the low speed side as compared with the example shown by the solid line in FIG. 2. Then, even when the vehicle speed SP is the same, the engine rotation speed NE becomes larger. As a result, as shown in FIG. 3, the output of the engine 10 increases in accordance with the engine rotation speed NE. In the process of step S21, the gear ratio is increased by shifting the gear range of the speed change mechanism Z to the low speed side, so that the process of step S21 corresponds to the gear ratio change process. Further, even when the process of step S21 is repeated a plurality of times between the start and the end of one execution of the temperature rise control of the filter 28, the increase process for increasing the upper limit value C is executed only once. After that, the increase processing execution unit 215 proceeds to the process of step S22.

In step S22, the upper limit value calculation unit 213 calculates the upper limit value C of the output of the engine 10 based on the operating state of the engine 10 at the time of processing in step S22. Specifically, the upper limit value calculation unit 213 calculates the upper limit value C based on the engine rotation speed NE, the air-fuel ratio in the cylinders 11, and the like. After that, the upper limit value calculation unit 213 proceeds to the process of step S23.

In step S23, the restriction processing execution unit 214 determines whether the second target value B at the time of processing in step S11 is equal to or less than the upper limit value C at the time of processing in step S22. In step S23, when the restriction processing execution unit 214 determines that the second target value B at the time of processing in step S11 is equal to or less than the upper limit value C at the time of processing in step S22 (S23: YES), the process proceeds to step S16.

As described above, when an affirmative determination is made in the process of step S13 or an affirmative determination is made in the process of step S23, the process proceeds to step S16. In step S16, the hybrid ECU 210 outputs a control signal based on the second target value B to the engine ECU 220. In this case, of the output of the engine 10, the output corresponding to the subtraction value obtained by subtracting the first target value A from the second target value B is converted into electric power by the power generation of the first motor generator 71 and charged in the battery 75. The hybrid ECU 210 also outputs control signals to the motor ECU 230, the battery ECU 240, the auxiliary machine ECU 250, and the air conditioning ECU 260. After that, the hybrid ECU 210 ends the current restriction control.

In step S23, when the restriction processing execution unit 214 determines that the second target value B at the time of processing in step S11 is larger than the upper limit value C at the time of processing in step S22 (S23: NO), the process proceeds to step S31.

In step S31, the restriction processing execution unit 214 executes the restriction process based on the upper limit value C and the first target value A. Specifically, the restriction processing execution unit 214 restricts the electric power generated by the first motor generator 71 so that, of the output of the engine 10, the output for power generation used for power generation of the first motor generator 71 is equal to the output corresponding to the subtraction value obtained by subtracting the first target value A from the upper limit value C. In this case, of the output of the engine 10, the output corresponding to the subtraction value obtained by subtracting the first target value A from the upper limit value C is converted into electric power by power generation of the first motor generator 71 and charged in the battery 75. After that, the process proceeds to step S32.

In step S32, the hybrid ECU 210 sets the upper limit value C as the second target value B and outputs a control signal based on the second target value B to the engine ECU 220. The hybrid ECU 210 also outputs control signals to the motor ECU 230, the battery ECU 240, the auxiliary machine ECU 250, and the air conditioning ECU 260. After that, the hybrid ECU 210 ends the current restriction control.

The operations of the present embodiment will be described. When the temperature rise control of the filter 28 is executed and the second target value B is larger than the upper limit value C, as shown in FIG. 5, the electric power generated by the first motor generator 71 is restricted so that, of the output of the engine 10, the output for power generation used for power generation of the first motor generator 71 is equal to the output D corresponding to the subtraction value obtained by subtracting the first target value A from the upper limit value C. As a result, compared to the case where the power generation of the first motor generator 71 is executed using the output exceeding the output D corresponding to the subtraction value obtained by subtracting the first target value A from the upper limit value C, the output of the engine 10 that can be actually used for traveling of the vehicle 100 increases.

The effect of the present embodiment will be described. It is possible to suppress the output that can be actually used for traveling of the vehicle 100 from becoming smaller than the vehicle required output required by the driver when the temperature rise control of the filter 28 is executed.

Hereinafter, other effects of the present embodiment will be described. (1) In the vehicle 100, when the execution of the temperature rise control of the filter 28 is started, the output of the engine 10 increases, and the electric power generated by the first motor generator 71 also increases. Here, the electric power generated by the first motor generator 71 can be increased at a speed higher than that of the output of the engine 10. Therefore, when the temperature rise control is executed, the output that can be used for traveling of the vehicle 100 may become temporarily smaller than the vehicle required output required by the driver as the electric power generated by the first motor generator 71 increases.

In this respect, in the present embodiment, the amount of change in the electric power generated by the first motor generator 71 from the output of the engine 10 per unit time is equal to or less than a specified value. As a result, the increase rate of the electric power generated by the first motor generator 71 is smaller as compared with the case where the amount of change in the electric power generated by the first motor generator 71 from the output of the engine 10 per unit time exceeds the specified value. This can suppress the output that can be used for traveling of the vehicle 100 from becoming temporarily smaller than the vehicle required output required by the driver as the electric power generated by the first motor generator 71 increases.

(2) In the vehicle 100, as indicated by the solid line in FIG. 2, since the gear range of the speed change mechanism Z is shifted in accordance with the vehicle speed SP, the engine rotation speed NE is uniquely determined in accordance with the vehicle speed SP. Then, as shown in FIG. 3, since the output of the engine 10 is determined in accordance with the engine rotation speed NE, the upper limit value C of the output of the engine 10 is likely to be restricted. In this case, even when the restriction process is executed, the output that can be actually used for traveling of the vehicle 100 may be smaller than the vehicle required output required by the driver.

In this respect, in the present embodiment, the gear ratio is increased by shifting the gear range of the speed change mechanism Z to the low speed side in the gear ratio change process in the increase process. Thus, even when the vehicle speed SP is constant, the engine rotation speed NE increases as the gear ratio of the speed change mechanism Z increases. As a result, the upper limit value C of the output of the engine 10 can be raised by increasing the engine rotation speed NE.

(3) If the first target value A does not include the auxiliary machine driving force for driving the auxiliary machine 66 and the air conditioning driving force for driving the air conditioner 67, the output actually used for traveling may become smaller as the auxiliary machine driving force and the air conditioning driving force change.

In the present embodiment, the first target value A is calculated as a value obtained by adding the target value of the auxiliary machine driving force for driving the auxiliary machine 66 and the target value of the air conditioning driving force for driving the air conditioner 67 to the target value of the output used for traveling of the vehicle 100. Thus, it is possible to suppress the output actually used for traveling of the vehicle 100 from becoming smaller as the auxiliary machine driving force and the air conditioning driving force change.

The present embodiment can be modified and implemented as follows. The present embodiment and modification examples described below may be carried out in combination of each other within a technically consistent range. In the above embodiment, the specified value used by the restriction processing execution unit 214 can be changed. For example, the amount of change in which the output of the engine 10 changes per unit time changes depending on the operating state of the engine 10. Therefore, the specified value used by the restriction processing execution unit 214 may be a value that is changed depending on the operating state of the engine 10.

In the above embodiment, the restriction processing execution unit 214 sets the amount of change in the electric power generated by the first motor generator 71 from the output of the engine 10 per unit time to a value equal to or less than the specified value when the temperature rise control of the filter 28 is executed. However, the above may be restricted to a value equal to or less than the specified value only when the restriction process is executed. Further, the restriction processing execution unit 214 does not have to restrict the amount of change in the electric power generated by the first motor generator 71 from the output of the engine 10 per unit time to a value equal to or less than the specified value. For example, when the difference between the amount of increase in the electric power generated by the first motor generator 71 per unit time and the amount of increase in the output of the engine 10 per unit time is small, there is little need to restrict the amount of change in the electric power generated by the first motor generator 71 from the output of the engine 10 per unit time to a value equal to or less than the specified value as described above.

In the above embodiment, the restriction processing execution unit 214 may restrict the electric power generated by the first motor generator 71 from the output of the engine 10 so that the output is less than the output D corresponding to the subtraction value obtained by subtracting the first target value A from the upper limit value C. With this configuration, compared to the case where the power generation of the first motor generator 71 is executed using the output exceeding the output D corresponding to the subtraction value obtained by subtracting the first target value A from the upper limit value C, the output of the engine 10 that can be actually used for traveling of the vehicle 100 increases.

In the above embodiment, the gear ratio change process in the increase process executed by the increase processing execution unit 215 can be changed. For example, it is not necessary to shift the gear range of the speed change mechanism Z to the low speed side. Specifically, the first motor generator 71, the second motor generator 72, the first planetary gear mechanism 40, and the second planetary gear mechanism 50 in the speed change mechanism Z can continuously change the gear ratio. Therefore, in the speed change mechanism Z, the gear ratio of the gear range can be continuously changed rather than being changed to a predetermined gear ratio. Therefore, in the gear ratio change process, the increase processing execution unit 215 may stop the control based on the gear range of the speed change mechanism Z and continuously change the gear ratio to obtain a larger gear ratio than the gear ratio corresponding to the current gear range.

In the above embodiment, the increase processing execution unit 215 may execute the air-fuel ratio change process for changing the air-fuel ratio in the cylinders 11 of the engine 10 to the rich side in place of or in addition to the gear ratio change process. Specifically, suppose that the air-fuel ratio in the cylinders 11 immediately before the start of the restriction process in step S21 is the first air-fuel ratio. In this case, the increase processing execution unit 215 may control the fuel injection valves 23 of the engine 10 so that the air-fuel ratio in the cylinders 11 becomes the second air-fuel ratio on the rich side of the first air-fuel ratio. Here, in a predetermined range in which the air-fuel ratio in the cylinders 11 of the engine 10 is close to the stoichiometric air-fuel ratio, generally, the richer the air-fuel ratio, the larger the torque of the engine 10. Thus, even when the engine rotation speed NE is the same, the torque of the engine 10 can be increased by executing the above-described air-fuel ratio change process. As a result, the upper limit value C of the output of the engine 10 can be raised by increasing the torque of the engine 10. When the gear ratio change process and the air-fuel ratio change process are executed together, the gear ratio change process and the air-fuel ratio change process correspond to the increase process.

In the above embodiment, the increase processing execution unit 215 does not have to execute the increase process. In this case, when a negative determination is made in the process of step S13, the process of step S31 may be performed.

In the above embodiment, the first target value calculation unit 211 may calculate the first target value A as a value that does not include one of the target value of the auxiliary machine driving force for driving the auxiliary machine 66 and the target value of the air conditioning driving force for driving the air conditioner 67. Further, the first target value calculation unit 211 may calculate the first target value A as a value that does not include both of the target value of the auxiliary machine driving force for driving the auxiliary machine 66 and the target value of the air conditioning driving force for driving the air conditioner 67.

In the above embodiment, the calculation process of the second target value B executed by the second target value calculation unit 212 can be changed. For example, the larger the PM accumulation amount PS, the higher the need to quickly raise the temperature of the filter 28 to burn the particulate matter in the filter 28. Therefore, in calculating the second target value B, the second target value calculation unit 212 calculates a larger predetermined value as the PM accumulation amount PS increases. The second target value calculation unit 212 may calculate a larger second target value B as the PM accumulation amount PS increases by adding the above-described predetermined value to the first target value A.

In the above embodiment, the automatic transmission 61 can be omitted. Also in this case, the first motor generator 71, the second motor generator 72, the first planetary gear mechanism 40, and the second planetary gear mechanism 50 can function as the speed change mechanism.

In the above embodiment, the vehicle does not have to include two motor generators, and only needs to include at least one motor generator. In this case, the vehicle only needs to be configured so that the motor generator can generate electric power using the output of the engine.

In the above embodiment, the exhaust treatment device is not limited to the filter 28. For example, in the case of executing, as the temperature rise control, a process of raising the temperature of the three-way catalyst 27 until the temperature reaches a temperature where the three-way catalyst 27 is activated, the three-way catalyst 27 serves as the exhaust treatment device.

What is claimed is:

1. A control device for a vehicle, the vehicle including an engine as a drive source, a motor generator as a drive source, a battery for storing electric power generated by the motor generator using an output of the engine, and an exhaust treatment device provided in an exhaust passage of the engine, the control device being configured to execute a temperature rise control that increases the output of the engine and raises a temperature of exhaust gas flowing into the exhaust treatment device, the control device comprising an electronic control unit configured to:
calculate a first target value that is a target value of the output of the engine used for traveling of the vehicle, based on an accelerator operation of a driver;
calculate a second target value that is a target value of the output of the engine and that is larger than the first target value, when executing the temperature rise control;
calculate an upper limit value of the output of the engine based on an operating state of the engine; and
execute a restriction process for restricting the electric power generated by the motor generator such that, of the output of the engine, an output for power generation used for power generation of the motor generator does not exceed an output corresponding to a subtraction value obtained by subtracting the first target value from the upper limit value, when the temperature rise control is executed and the second target value is larger than the upper limit value.

2. The control device according to claim 1, wherein the electronic control unit is configured to set an amount of change in the electric power generated by the motor generator per unit time to a value equal to or less than a specified value when the restriction process is executed.

3. The control device according to claim 1, wherein the electronic control unit is configured to execute an increase process for increasing the upper limit value when the temperature rise control is executed and the second target value is larger than the upper limit value.

4. The control device according to claim 3, wherein:
the vehicle has a speed change mechanism on a power transmission path between the engine and drive wheels, the speed change mechanism being configured to change a gear ratio that is a ratio of a rotation speed of the drive wheels with respect to a rotation speed of the engine; and
the increase process is a gear ratio change process for increasing the gear ratio of the speed change mechanism.

5. The control device according to claim 4, wherein:
the speed change mechanism is a speed change mechanism configured to change the gear ratio stepwise; and
the gear ratio change process is a process of shifting a gear range of the speed change mechanism to a low speed side.

6. The control device according to claim 3, wherein the increase process is a process of changing an air-fuel ratio in cylinders of the engine to an air-fuel ratio on a rich side.

7. The control device according to claim 1, wherein the electronic control unit is configured to calculate a value obtained by adding at least one of an auxiliary machine driving force for driving an auxiliary machine and an air conditioning driving force for driving an air conditioner to an output used for traveling of the vehicle as the first target value.
